(19) United States
(12) Patent Application Publication
(10) Pub. No.: US 2015/0293697 A1
(43) Pub. Date: Oct. 15, 2015

(54) ASSIGNING KEYBOARD SHORTCUT KEYS TO WEB PAGE RESOURCE LOCATORS

(71) Applicant: Hao Fang, Beijing (CN)

(72) Inventor: Hao Fang, Beijing (CN)

(73) Assignee: Google Inc., Mountain View, CA (US)

(21) Appl. No.: 14/381,879

(22) PCT Filed: Mar. 15, 2012
(86) PCT No.: PCT/CN2012/072379

§ 371 Date: Jun. 10, 2015

(51) Int. Cl. G06F 3/0489; G06F 3/0485; G06F 3/0484

(52) U.S. Cl. CPC G06F 3/04892; G06F 3/04842; G06F 3/0485

(57) ABSTRACT

A first web page referenced by a first resource locator is displayed in a user interface. The first web page includes second resource locators, each of which respectively references a corresponding second web page. A likelihood of selection of a particular second resource locator in the first web page is determined to be greater than respective likelihoods of selection of each of the remaining second resource locators in the first web page. A keyboard shortcut key is defined to the particular second resource locator such that a selection of the keyboard shortcut key results in a selection of the particular second resource locator. An indicator is displayed in the user interface indicating that the keyboard shortcut key is assigned to the particular second resource locator such that a request for the corresponding second web page is received in response to the selection of the keyboard shortcut key.

### CROSS-REFERENCE TO RELATED APPLICATIONS

This application is a National Stage Application under 35 U.S.C. §371 and claims the benefit of priority to International Application No. PCT/CN2012/072379, titled “Assigning Keyboard Shortcut Keys to Web Page Resource Locators,” filed on Mar. 15, 2012. The disclosure of the foregoing application is incorporated herein by reference in its entirety for all purposes.

### BACKGROUND

This document relates to accessing web pages of websites.

Publishing systems include one or more computers that collectively host resources. For example, Internet publishing systems host websites, each of which is a collection of web pages. Each web page is a resource that the publishing system stores and provides to requesting devices.

A publishing system assigns a resource locator (for example, a Uniform Resource Locator) to a web page to reference the web page. A user of a client device connected to the Internet can request a web page by providing the resource locator in a user interface (for example, an Internet browser). Upon receiving the request, the publishing system can access the web page referenced by the resource locator, and provide the web page to the client device. The client device can present web page in the user interface.

In some situations, a publishing system can encode a particular web page to include resource locators that reference other web pages. When the client device presents the particular web page in the user interface, a user can select a resource locator that references another web page to access the other web page. For example, a user can select the resource locator using a position indicator (for example, a cursor) controlled by a positioning device (for example, a mouse). Alternatively, the resource locator can be selected by a keyboard shortcut key, for example, a key on a keyboard connected to the client device, the selection of which causes a selection of the resource locator.

Some of the resource locators are links to other web pages at other web sites, and some of the resource locators are links to related web pages (for example, web pages that are intended to be presented in sequence, such as a series of web pages that collectively present a multi-page news story.

### SUMMARY

This document describes technologies relating to assigning keyboard shortcut keys to web page resource locators.

In general, one innovative aspect of the subject matter described here can be implemented as a method implemented by data processing apparatus. It is determined, by a data processing apparatus, that a first web page referenced by a first resource locator is displayed in a user interface. The first web page referenced by the first resource locator includes second resource locators. Each of the second resource locators respectively references a corresponding second web page. It is determined, by the data processing apparatus, that a likelihood of selection of a particular second resource locator in the first web page is greater than respective likelihoods of selection of each of the remaining second resource locators in the first web page. Data defining a keyboard shortcut key to the particular second resource locator is generated by the data processing apparatus such that a selection of the keyboard shortcut key results in a selection of the particular second resource locator. The data includes instructions that cause a display of an indicator in the user interface indicating that the keyboard shortcut key is assigned to the particular second resource locator, and cause a request for the corresponding second web page in response to the selection of the keyboard shortcut key.

This, and other aspects, can include one or more of the following features. The first web page can be referenced by a third web page that, in turn, can be referenced by a third resource locator. Determining that the likelihood of selection of the particular second resource locator is greater than the respective likelihoods of selection of each of the remaining second resource locators can include determining, for each second resource locator, a similarity measure that is a measure of similarity of the first resource locator, the second resource locator, and the third resource locator, and determining that a similarity measure for the particular second resource locator is greater than a similarity measure of each other second resource locator. In response, it can be determined that the likelihood of selection of a particular second resource locator in the first web page is greater than respective likelihoods of selection of each of the remaining second resource locators in the web page. Determining a similarity measure that is a measure of similarity of the first resource locator, the second resource locator, and the third resource locator can include, for each second resource locator generating a candidate resource locator, the candidate resource locator based on the third resource locator and the first resource locator, comparing the candidate resource locator to each of the second resource locators to identify a second resource locator that is most similar to the candidate resource locator, and identifying the most similar second resource locator as the particular second resource locator. Identifying the most similar second resource locator as the particular second resource locator can include verifying that the candidate resource locator references an existing web page and only identifying the most similar second resource locator as the particular second resource locator in response to a positive verification. The third resource locator and the first resource locator can include common address data and variable address data. The common address data can be the same for each of the third and first resource locators. The variable address data for the first resource locator can be different from the variable address data for the third resource locator. Generating the candidate resource locator can include identifying the common address data from the first resource locator and the third resource locator, determining a pattern change defined by the variable address data of the first resource locator and the variable address data of the third resource locator, and generating candidate variable address data based on the pattern change and the common address data of the first resource locator and the variable address data of the third resource locator. Identifying the most similar second resource locator as the particular second resource locator can include identifying the second resource locator that most closely matches a combination of the common address data and the candidate variable address data. It can be determined that the likelihood of selection of the particular second resource locator to display the corresponding web page in the user interface is greater than the respective likelihood of selection of each of the remaining second resource locators of a plurality of resource locators comprises determining that a number of times that selections of the particular second resource locator were received from the first web page in the past is greater than each respective number of times that selections of each of the remaining resource locators were received from the first web page in the past. Occurrences of displaying the first web page can be tracked. Respective selections of each second resource locator from the display of the first web page can be tracked. The second resource locator with most tracked selections can be determined. The second resource locator with most tracked selections as the particular second resource locator can be identified. Tracking respective selections of each resource locator can include excluding a selection of each resource locator using a corresponding keyboard shortcut key. The data can include instructions to display an object in a first color in the user interface before assigning the keyboard shortcut key to the second resource locator, display the object in a second color, different from the first color, after assigning the keyboard shortcut key to the second resource locator. A keyboard shortcut key can be a key on a keyboard connected to a display device in which the user interface is displayed.

Another innovative aspect of the subject matter described here can be implemented as a computer storage medium encoded with a computer program, the program comprising instructions that when executed by data processing apparatus cause the data processing apparatus to perform operations described here. A further innovative aspect of the subject matter described here can be implemented as a system including data processing apparatus, and a computer storage medium encoded with a computer program, the program comprising instructions that when executed by the data processing apparatus cause the data processing apparatus to perform operations described here.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C shows a first environment in which resources are provided to requesting devices.

FIGS. 2A-2C show a system for assigning keyboard shortcut keys to resource locators that reference web pages.

FIG. 3 illustrates a system for verifying that a resource locator references a web page.

FIG. 4 illustrates a user interface in which keyboard shortcut keys are assigned to resource

FIG. 5 is a flowchart of an example process for assigning keyboard shortcut keys to resource

Like reference numbers and designations in the various drawings indicate like elements.

### DETAILED DESCRIPTION

A client device can present a first web page referenced by a first resource locator (for example, a Uniform Resource Locator (URL)) in a display device. In the first web page, the client device can present multiple second resource locators that each references a respective second web page. The client device can detect a selection of a second resource locator and, in response, can receive a second web page referenced by the selected resource locator from a server system. The client device can then present the second web page referenced by the selected resource locator in the display device.

In some implementations, a process determines that a particular second resource locator is more likely to be selected than other second resource locators displayed in the first web page. This decision can, for example, be based in part on a similarity of the particular second resource locator to the first resource locator or on a selection history of the particular second resource locator determined from past presentations of the first web page or combinations of them. A keyboard shortcut key (for example, a key on a keyboard connected to the client device) can be assigned to the particular second resource locator such that a selection (for example, a pressing) of the keyboard shortcut key causes a selection of the particular second resource locator, which, in turn, causes a request to be sent to the server system for the second web page referenced by the particular second resource locator. In this manner, the keyboard shortcut key can be selected to select the particular second resource locator. The techniques described here can be implemented either by the client device or by the server system or by combinations of them.

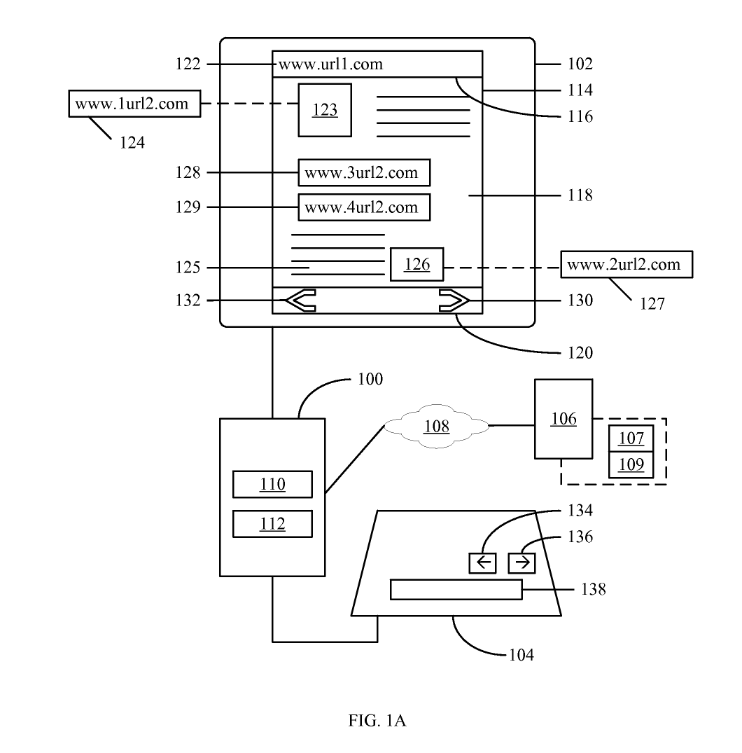

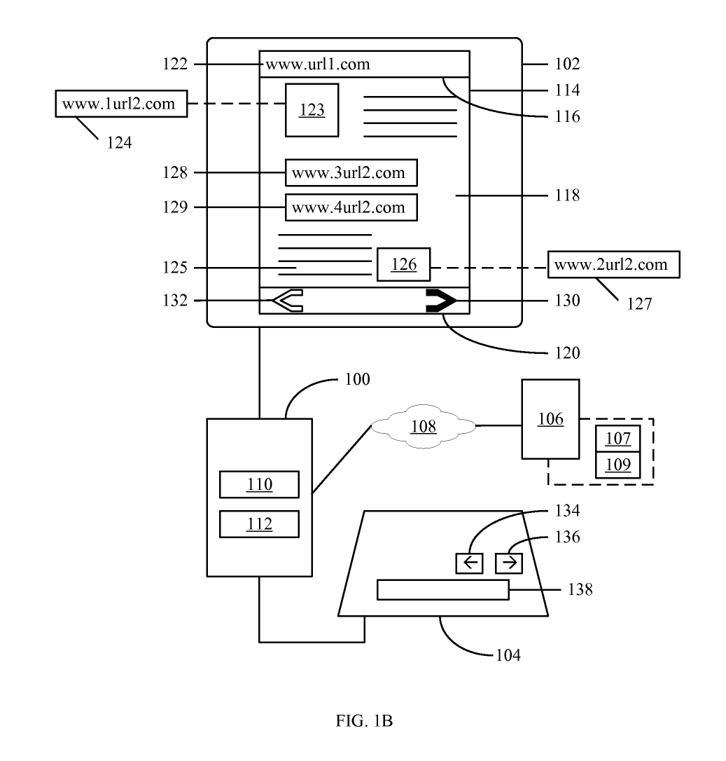

FIGS. 1A-1C shows a first environment in which resources are provided to requesting client devices. As shown in FIG. 1A, a client device 100 (for example, a computer system) 100 is connected to a server system 106 (for example, one or more computers) through one or more wired or wireless networks 108 (for example, the Internet). The client device 100 includes a computer-readable medium 110 that encodes computer programs and data processing apparatus 112 that execute the computer programs to perform operations described here. The client device 100 is connected to a display device 102 and input devices (for example, a keyboard 104).

The client device 100 can receive a first resource locator that references a first web page including resources hosted by the server system 106. For example, the client device 100 can display a web page that includes the first resource locator and can detect a selection of the first resource locator. In response, the client device 100 can transmit a request for the first web page to the server system 106 through the network 108.

The server system 106 includes a computer-readable medium 107 that encodes computer programs and data processing apparatus 109 that execute the computer programs to perform operations. The server system 106 is connected to one or more data storage systems (not shown) that store resources such as those included in the first web page requested by the client device 100. Alternatively, or in addition, the server system 106 can store resources on the computer-readable medium 107. Upon receiving the request for the first web page from the client device 100, the server system 106 can identify the resource and can transmit the resources to the client device 100 through the network 108.

The client device 100 can receive the resource, execute the code defining the resource (for example, HTML), and present the resource as the first web page 114 in a user interface (for example, an Internet browser window) in a display device 102. In some implementations, the client device 100 can display the first web page 114 to include a top portion 116 and a middle portion 118. In the top portion 116, the client device 100 can display the first resource locator 122 (for example, a first URL such as www.url1.com) that references the first web page 114. In the middle portion 118, the client device 100 can display additional data (for example, an image 123, text 125, and a video 126) received from the server system 106 as encoded by the server system 106.

Additional resources are referenced in the first web page 114 by respective resource locators, for example, URLs 124, 127, 128 and 129. Typically these resource locators are embedded in the form of hyperlinks with anchor text, or embedded with an image or video. Selection of one of the URLs (for example, selection of a respective hyperlink or image) results in a request being sent to a respective server that hosts the resource referenced by the URL. Thus, each of the resource locators in the first web page is selectable such that a selection causes the client device 100 to present a respective second resource (for example, a second web page) referenced by the selected resource locator in the display device 102.

In some implementations, the client device 100 can determine that a likelihood of selection of a particular resource locator that references a second web page (for example, the second resource locator 128) is greater than respective likelihoods of selection of each of the remaining resource locators that references another second web page. Subsequently, the client device 100 can generate data defining a keyboard shortcut key (for example, the first key 134 or the second key 136) to the particular second resource locator such that a selection of the keyboard shortcut key results in a selection of the particular second resource locator. The data can include instructions that cause a display of an indicator (for example, a first indicator 130 or a second indicator 132) in the user interface (for example, in the bottom portion 120) indicating that the keyboard shortcut key is assigned to the particular second resource locator, and cause a request for the corresponding second web page in response to the selection of the keyboard shortcut key.

For example, as shown in FIG. 1B, the first indicator 130 and the second indicator 132 can be an image of a right-facing pointer and a left-facing pointer, respectively. The first key 134 and the second key 136 can be a left arrow and a right arrow, respectively. The client device 100 can determine that the second resource locator 128 is more likely to be selected than the third resource locator 124, the fourth resource locator 127, or the fifth resource locator 129. In response, the client device 100 can define the second key 136 (i.e., the right arrow key) as the keyboard shortcut key. Further, the client device 100 can cause the first indicator 130 to be displayed in a color that is different from the color of the first indicator 130 prior to defining the keyboard shortcut key. In this manner, the client device 100 can communicate that the second key 136 has been defined as a keyboard shortcut key. If the client device 100 detects a selection of the second key 136, then the client device 100 can transmit a request for a second web page referenced by the second resource locator 128 to the server system 106.

As shown in FIG. 1C, the client device 100 can receive the second web page 160 from the server system 106, and present the second web page 160 in the display device 102 adjacent to or in place of the first web page 114. For example, the client device 100 can display the second resource locator 128 in a top portion 162 of the second web page 160, and indicators (for example, a third indicator 168 and a fourth indicator 170) in a bottom portion 166 of the second web page 160. Because the client device 100 no longer defines a keyboard shortcut key, then the client device 100 can display the third indicator 168 in the same color as prior to defining the keyboard shortcut key.

When displaying the second web page 160, the client device 100 can define the first key 134 (i.e., the left arrow key) as a keyboard shortcut key to the first resource locator 122 such that the selection of the first key 134 will cause a selection of the first resource locator 122 resulting in the first web page 114 being displayed in the display device 102. In such situations, the client device 100 can cause the fourth indicator 170 to be displayed in a color different from the color in which the client device 100 displayed the fourth indicator 170 prior to defining the keyboard shortcut key. In this manner, the client device 100 can communicate that the first key 134 is an equivalent of a “Back” button in an Internet browser window.

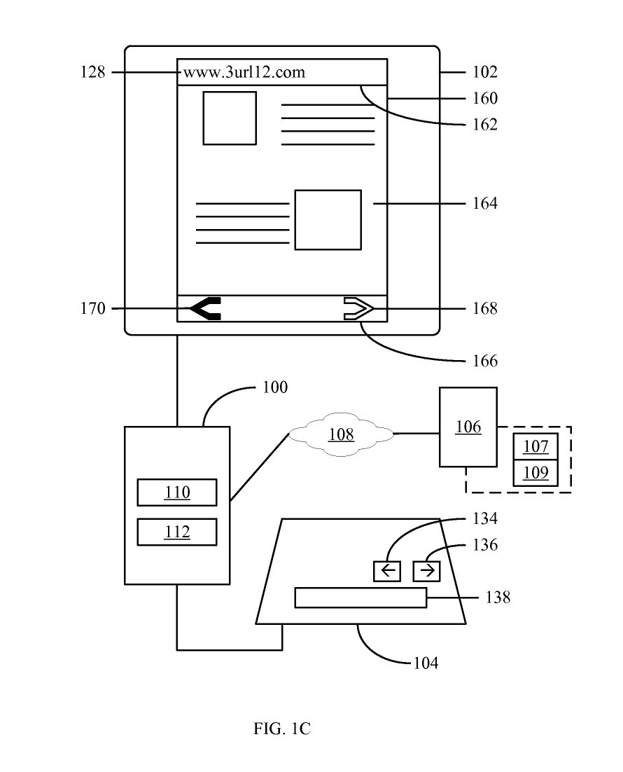

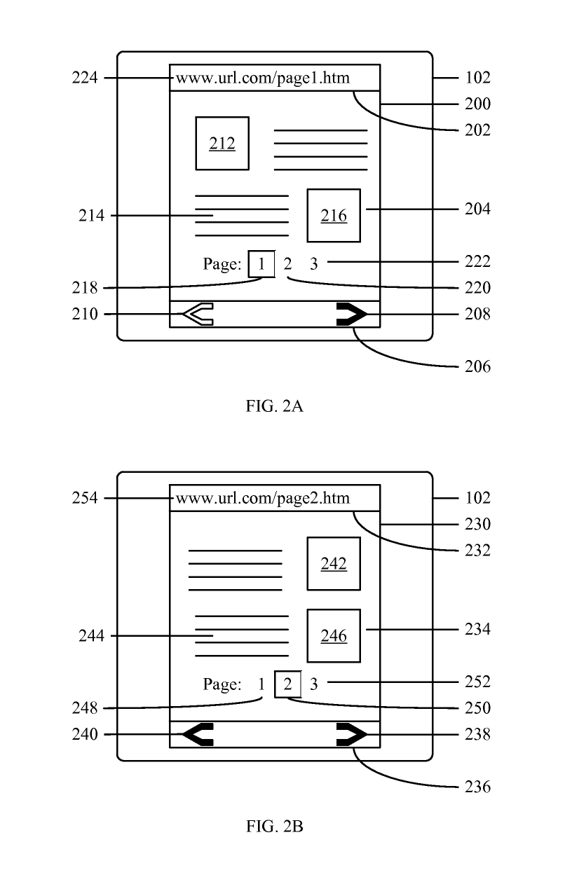

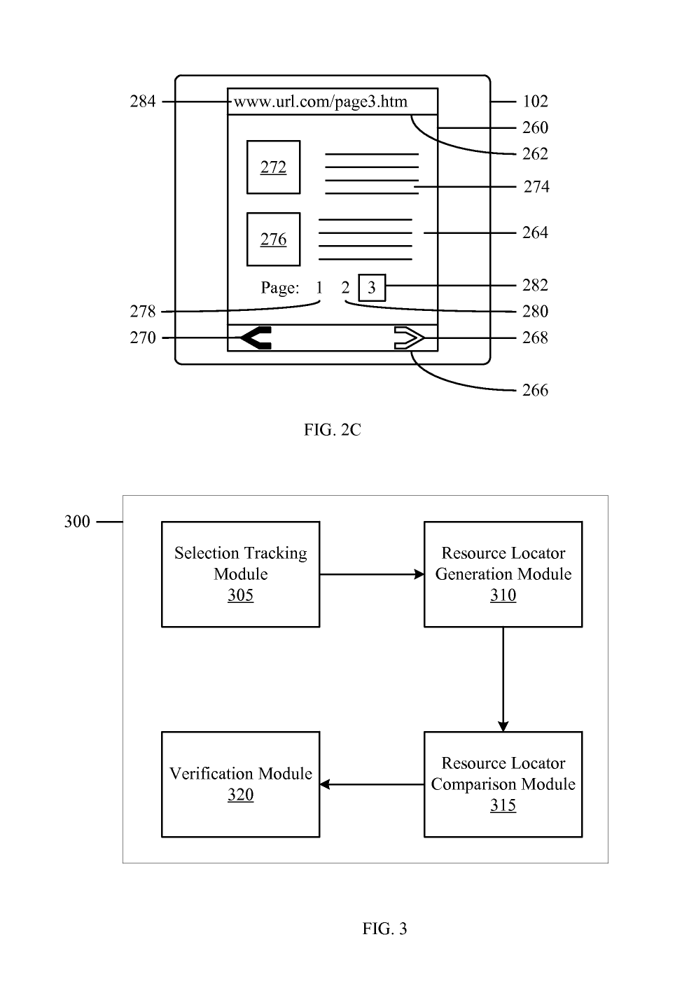

In some implementations, for example as described with reference to FIGS. 2A-C, the client device 100 can determine that a likelihood of selection of a particular resource locator in a web page displayed in the display device 102 is greater than respective likelihoods of selection of each of the remaining resource locators in the web page based, in part, on a similarity of three resource locators—(i) the particular resource locator, (ii) the resource locator that references the web page, and (iii) another resource locator that references another web page in which the resource locator of the web page is displayed. FIG. 2A, FIG. 2B, and FIG. 2C show a first web page 200, a second web page 230, and a third web page 260, respectively, which are respectively referenced by a first resource locator 224 (for example, www.url.com/page1.htm), a second resource locator 254 (for example, www.url.com/page2.htm), and a third resource locator 284 (for example, www.url.com/page3.htm), respectively.

For example, the first, second, and third web pages can be three web pages of a website that have been numbered sequentially and across which content, for example, a multi-page news article, is distributed. A user of the client device 100 can request the first web page 200 and the second web page 230 in a sequence. For example, as a first selection in a two-selection sequence, the user can request the first web page 200 by entering the first resource locator 224 in an Internet browser window or by selecting the first resource locator 224 that is displayed in another web page. As a second selection in the two-selection sequence, the user can select the second resource locator 254 that is displayed within the first web page 200 to request the second web page 230, which, in turn, includes the third resource locator 284.

As shown in FIG. 2A, the client device 100 displays the first web page 200 in the display device 102, for example, in response to receiving or detecting a selection of the first resource locator 224. In a top portion 202 of the first web page 200, the client device 100 can display the first resource locator 224. In a middle portion 204 of the first web page 200, the client device 100 can display multiple embedded hyperlinks 212, 214, 216, 220, and 222. Each of the hyperlinks references respective resource locators, which, in turn references a respective web page. For example, the hyperlink 220 can represent the second resource locator 254 referencing the second web page 230, and the hyperlink 222 can represent the third resource locator 284 referencing the third web page 260 that are each part of a multi-page article. Indicator 218 can represent that the first web page 200 is a first of many web pages (for example, the first of three web pages). In a bottom portion 206 of the first web page 200, the client device 100 can display a “forward” indicator 208 and a “back” indicator 210. In FIG. 2A, the links are not colored or highlighted, indicating that a keyboard shortcut is not associated with either link.

Selection of the hyperlink 220 results in the serving of the page 230, shown in FIG. 2B, and which is referenced by the resource locator 254. The page 230 includes embedded hyperlinks 242, 244, and 246 to other pages. Likewise, selection of the hyperlink 252 results in the serving of the page 260, shown in FIG. 2C, and which is referenced by the URL 284, and selection of the hyperlink 248 results in the serving of page 200, shown in FIG. 2A. The page 260 includes embedded hyperlinks 272, 274 and 276 to other pages, and hyperlinks 278 and 280, which link to pages 200 and 230, respectively.

The client device 100 can determine, for each resource locator embedded in a resource, e.g., such as the resource locators embedded in web page 230, a corresponding similarity measure. The similarity measure is a measure of similarity of the resource locator of the page, e.g., resource locator 254 of web page 230, to resource locators embedded in the web page 230. Each similarity measure can be based on a comparison of two or more resource locators. For example, the client device 100 can determine a first similarity measure for the resource locator 242, the first resource locator 224, and the second resource locator 254. The client device 100 can similarly determine a second similarity measure for the resource locator 246, the first resource locator 224, and the second resource locator 254. In addition, the client device 100 can determine a third similarity measure for the third resource locator 284 represented by the resource 260, the first resource locator 224, and the second resource locator 254. Thus, the similarity measure for a particular resource locator is determined based on a similarity between the particular resource locator, the first resource locator 224 and the second resource locator 254. The first resource locator 224 and the second resource locator 254 are determined based on a sequence of selections of resource locators by the user of the client device 100, as described above.

To determine the third similarity measure, the client device 100 generates a candidate resource locator based on the first resource locator 224 and the second resource locator 254. To generate the candidate resource locator, the client device 100 can identify common address data from the first resource locator 224 and the second resource locator 254. The common address data are the same for each of the first and second resource locators. As described above, the first, second, and third resource locators can be, for example, www.url.com/page1.htm, www.url.com/page2.htm, and www.url.com/page3.htm, respectively. The common address data in each of the first resource locator 224 and the second resource locator 254 is, therefore, www.url.com/page!.htm, where ! is a wildcard.

The client device 100 can then determine variable address data for the first resource locator 224 and the second resource locator 254. The variable address data is the portion of the first resource locator 224 that is different from the second resource locator 254. The numbers “1” and “2” in the first resource locator 224 and the second resource locator 254, respectively, are variable address data, in this example. Having identified the variable address data, the client device 100 can then determine a pattern change defined by the variable data of the first resource locator 224 and the variable address data of the second resource locator 254. In this example, the client device 100 can determine that the pattern change between the variable address data of the first resource locator 224 and that of the second resource locator 254 is an increment by 1.

Subsequently, the client device 100 can generate candidate variable address data based on the pattern change and the common address data. In this example, the client device 100 can determine that the common address data for the candidate resource locator is www.url.com/page_.htm, and that the variable address data for the candidate resource locator is either “1” or “2.” From this determination, the client device 100 can determine that two patterns of variable address data are possible—“0”, “1”, “2” or “1”, “2”, “3”. Accordingly, the client device 100 can generate candidate resource locators that share the same common address data as the first resource locator 224 and the second resource locator 254—www.url1.com/page_.htm—but that each includes one of the generated variable address data. In this example, the client device 100 can generate www.url1.com/page0.htm and www.url1.com/page3.htm as candidate resource locators. For each candidate resource locator, the client device 100 then identifies the most similar resource locator that references a resource in the second web page 230 as the resource locator that most closely matches the candidate resource locator.

To do so, the client device 100 compares each candidate resource locator with each resource locator that references a resource in the second web page 230. In this example, such a comparison will reveal that the third resource locator 284 (www.url1.com/page3.htm) more closely matches the candidate resource locator www.url1.com/page3.htm than any other resource locator referencing a resource displayed in the second web page 230. In this manner, the client device 100 can determine that the third resource locator 284 has a greater similarity measure than a similarity measure of each other resource locator that references a respective resource in the second web page 230, and consequently a greater likelihood of selection. Subsequently, the client device 100 can generate data defining a keyboard shortcut key to the third resource locator 284 such that a selection of the keyboard shortcut key results in a selection of the third resource locator 284.

In some situations, the client device 100 can determine that more than one candidate resource locator closely matches a resource locator in the second web page 230. For example, the second web page 230 can include the third resource locator 284 (www.url1.com/page3.htm), as described above, and another resource locator (www.url1.com/page0.htm). Consequently, both candidate resource locators generated above closely match resource locators on the second web page 230. In such situations, the client device 100 can generate defining a respective keyboard shortcut key to each of the two resource locators in the second web page 230. For example, the client device 100 can use pattern matching to assign a “Previous” shortcut key to www.url1.com/page0.htm and to assign a “Next” shortcut key to www.url1.com/page3.htm based on determining an increase in the sequence “0”, “1”, “2” and “3” in the variable resource data of the resource locators.

In the data, the client device 100 includes instructions that cause a display of an indicator (for example, the “forward” indicator 238 in the bottom portion 236 of the second web page 230) indicating that the keyboard shortcut key is assigned to the third resource locator 284. In addition, the client device 100 can display a “back” indicator 240 in the bottom portion 236. In the data, the client device 100 can further include instructions that cause a request for the third web page 260 in response to a selection of the keyboard shortcut key.

If the client device 100 also identifies another resource in the second web page 260 which is referenced by another resource locator (for example, www.url1.com/page0.htm) that closely matches the other candidate resource locator (i.e., www.url1.com/page0.htm), then the client device 100 defines another keyboard shortcut key to the other resource locator. For example, because www.url1.com/page0.htm references a web page that precedes the second web page 230 and www.url1.com/page3.htm references the third web page 260 that follows the second web page 230, the client device 100 can define a left arrow key as the keyboard shortcut key for the former resource locator and a right arrow key as the keyboard shortcut key for the latter resource locator.

As shown in FIG. 2C, upon detecting a selection of the keyboard shortcut key (for example, a right arrow key), the client device 100 requests for and receives the third web page 260 and included resources, and displays the third web page 260 in the display device 102. Similarly to the first and second web pages, the client device 100 displays the third resource locator 284 in a top portion 262 of the third web page 260, and a “forward” indicator 268 and a “backward” indicator 270 in a bottom portion 266 of the third web page 260, respectively.

In some implementations, described with reference to FIG. 3, the client device 100 includes a system 300 that verifies that a resource locator references a web page. For example, the system 300 includes a selection tracking module 305 that detects a selection of a resource locator such as the second resource locator 254 displayed in a web page such as the first web page 200. The system 300 includes a resource locator generation module 310 that generates candidate resource locators as described above. The system 300 additionally includes a resource locator comparison module 315 that compares the candidate resource locators to each of the resource locators associated with the second web page 230 to identify the most similar resource locator (i.e., the third resource locator 284, in this example) as the resource locator for defining a keyboard shortcut key. The system 300 includes a verification module 320 that verifies that the candidate resource locator, which most closely matches the resource locator for which the keyboard shortcut key is to be defined, references an existing web page. To do so, in some implementations, the verification module 320 can transmit the candidate resource locator over the network 108 to determine if a web page referenced by the candidate resource locator is hosted by any server system. The verification module 320 communicates a positive verification to the client device 100, which then defines the keyboard shortcut key. Each module in system 300 can include computer-readable media encoding instructions executable by data processing apparatus (for example, data processing apparatus 110) to perform the operations of each module.

In some implementations, when the verification module 320 determines that a web page referenced by the candidate resource locator is hosted by a server system, the client device 100 can obtain and locally store the web page. For example, after the client device 100 has served the second web page 230 to the user, the client device 100 can locally store the third web page 260, identified using the techniques described above, so that when the user selects the keyboard shortcut key, the client device 100 can retrieve the locally stored third web page 260 instead of transmitting a request to the server that hosts the third web page 260 and then receiving the third web page 260. In this manner, by locally storing the third web page 260, the client device 100 can serve the third web page 260 faster relative to retrieving the third web page 260 over the network and then serving the third web page 260.

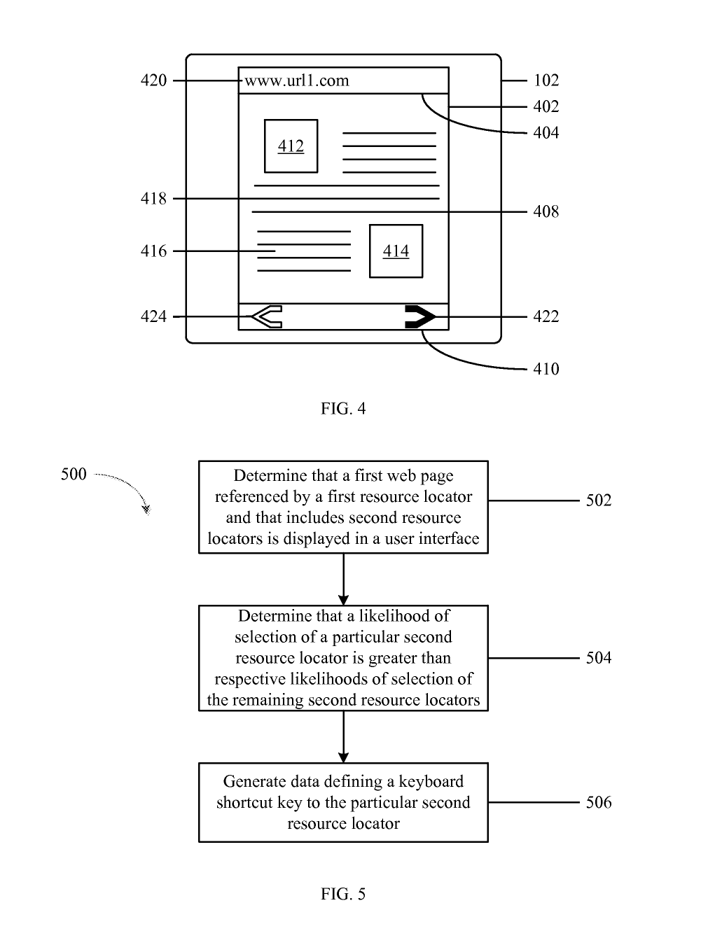

In another implementation, a server is used to determine the resource locater that is most likely to be selected in a given web page. In addition to the performing functions similar to the client side implementation that compares similarity of resource locators, the server side system can alternatively determine the resource that is most likely to be selected based on historical data of multiple users. FIG. 4 illustrates a user interface in which keyboard shortcut keys are assigned to resource locators that reference web pages. As shown in FIG. 4, a server system (for example, a server system 106) can cause a client device to display a web page 402 in a display device 102. The server system can cause the client device 100 to display a first resource locator 420 (for example, www.url1.com) that references the web page 402 in a top portion 404 of the web page 402. The client device displays content, e.g., image 412, video 414, and text 416 each of which have an embedded resource locator. Assume the resource locator embedded in the text 416 is more often selected than the resource locators embedded in the video 414 and the image 412. By tracking past selections of resource locators included in the web page 402, the server system determine that a likelihood of selection of the second resource locator embedded in the text is greater than respective likelihoods of selection of each of the remaining resource locators embedded in the content of the web page 402.

In some implementations, the server system makes this determination by determining that a number of times that selections of the resource locator embedded in the text 416 received from the web page 402 in the past is greater than each respective number of times that selections of each of the remaining resource locators were received from the web page 402 in the past. In response, the server system can define a keyboard shortcut key to the resource locator embedded in the text 416. In the bottom portion 410 of the web page 402, the server system can cause the client device 100 to display a “forward” indicator 422 and a “back” indicator 424. Subsequent to defining the keyboard shortcut key, the server system can cause the client device 100 to display the “forward” indicator 422 in a color that is different from a color prior to defining the keyboard shortcut key.

FIG. 5 is a flowchart of an example process 500 for assigning keyboard shortcut keys to resource locators that reference web pages. The process 500 can be implemented, in some implementations, on a server system, and in other implementations, on client device.

The process 500 determines that a first web page referenced by a first resource locator is displayed in a user interface (step 502). The first web page referenced by the first resource locator includes second resource locators. Each of the second resource locators respectively references a corresponding second web page.

The process 500 determines that a likelihood of selection of a particular second resource locator in the first web page is greater than respective likelihoods of selection of each of the remaining second resource locators in the web page (step 504).

In example server side implementations, upon receiving permissions from multiple users, a server system tracks selections of resource locators from the first page referencing respective second web pages by each user. In some implementations, the server system tracks respective selections of each resource locator by excluding selections of each resource locator using a corresponding keyboard shortcut key to reduce selection bias. In such implementations, the server system considers a resource locator to have been selected as long as the selection was not done by use of an assigned shortcut key. Based on the tracking, the server system determines and stores a number of times that a resource locator has been selected for each resource and for each web page, and selects the resource locator with the highest number as the resource locator that is most likely to be selected.

In the client side implementation, or an in alternate server side implementation, the process 500 determines a similarity measure for each of the second resource locators. The similarity measure is a measure of similarity of the first resource locator of the web page, a second resource locator in the web page, and, optionally, a third resource locator of another web page that includes the first resource locator. The second resource locator with the highest similarity measure id selected as the resource locator that is most likely to be selected.

The process 500 generates data defining a keyboard shortcut key to the particular second resource locator (step 506). For example, the server can generate the data when serving the web page, or the client device can generate the data after the web page is received, depending on the implementation. A selection of the keyboard shortcut key results in a selection of the particular second resource locator. The data includes instructions that cause a display of an indicator in the user interface indicating that the keyboard shortcut key is assigned to the particular second resource locator, and cause a request for the corresponding second web page in response to a selection of the keyboard shortcut key.

The data includes instructions to display an object in a first color in the user interface before assigning the keyboard shortcut key to the second resource locator, and display the object in a second color, different from the first color, after assigning the keyboard shortcut key to the second resource locator. The difference in color communicates that a keyboard shortcut key has been assigned to a resource locator in the web page.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementations or of what may be claimed, but rather as descriptions of features specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The indicators and the pre-determined keys described here are exemplary. Any image can be assigned as an indicator and displayed in the web page to communicate that a keyboard shortcut key has been assigned. Similarly, any key on a keyboard (for example, a physical keyboard or a virtual keyboard) can be defined as a keyboard shortcut key.

What is claimed is:

1. A method performed by data processing apparatus, the method comprising:
determining, by a data processing apparatus, that a first web page referenced by a first resource locator is displayed in a user interface, wherein the first web page referenced by the first resource locator includes second resource locators, each of the second resource locators respectively referencing a corresponding second web page;
determining, by the data processing apparatus, that a likelihood of selection of a particular second resource locator in the first web page is greater than respective likelihoods of selection of each of the remaining second resource locators in the first web page; and
generating, by the data processing apparatus, data defining a keyboard shortcut key to the particular second resource locator such that a selection of the keyboard shortcut key results in a selection of the particular second resource locator, wherein the data includes instructions that:
cause a display of an indicator in the user interface indicating that the keyboard shortcut key is assigned to the particular second resource locator, and
cause a request for the corresponding second web page in response to the selection of the keyboard shortcut key.

2. The method of claim 1, wherein:
the first web page is referenced by a third web page that, in turn, is referenced by a third resource locator; and
determining that the likelihood of selection of the particular second resource locator is greater than the respective likelihoods of selection of each of the remaining second resource locators comprises:
determining, for each second resource locator, a similarity measure that is a measure of similarity of the first resource locator, the second resource locator, and the third resource locator; and
determining that a similarity measure for the particular second resource locator is greater than a similarity measure of each other second resource locator, and, in response, determining that the likelihood of selection of a particular second resource locator in the first web page is greater than respective likelihoods of selection of each of the remaining second resource locators in the web page.

3. The method of claim 2, wherein determining a similarity measure that is a measure of similarity of the first resource locator, the second resource locator, and the third resource locator comprises, for each second resource locator:
generating a candidate resource locator, the candidate resource locator based on the third resource locator and the first resource locator;
comparing the candidate resource locator to each of the second resource locators to identify a second resource locator that is most similar to the candidate resource locator; and
identifying the most similar second resource locator as the particular second resource locator.

4. The method of claim 3, wherein identifying the most similar second resource locator as the particular second resource locator comprises verifying that the candidate resource locator references an existing web page and only identifying the most similar second resource locator as the particular second resource locator in response to a positive verification.

5. The method of claim 3, wherein:
the third resource locator and the first resource locator include common address data and variable address data, and wherein the common address data are the same for each of the third and first resource locators, and the variable address data for the first resource locator is different from the variable address data for the third resource locator; and
wherein generating the candidate resource locator comprises:
identifying the common address data from the first resource locator and the third resource locator;
determining a pattern change defined by the variable address data of the first resource locator and the variable address data of the third resource locator; and
generating candidate variable address data based on the pattern change and the common address data of the first resource locator and the variable address data of the third resource locator; and
identifying the most similar second resource locator as the particular second resource locator comprises identifying the second resource locator that most closely matches a combination of the common address data and the candidate variable address data.

6. The method of claim 1, further comprising determining that the likelihood of selection of the particular second resource locator to display the corresponding web page in the user interface is greater than the respective likelihood of selection of each of the remaining second resource locators of a plurality of resource locators comprises determining that a number of times that selections of the particular second resource locator were received from the first web page in the past is greater than each respective number of times that selections of each of the remaining resource locators were received from the first web page in the past.

7. The method of claim 6, further comprising:
tracking occurrences of displaying the first web page;
tracking respective selections of each second resource locator from the display of the first web page;
determining the second resource locator with most tracked selections; and
identifying the second resource locator with most tracked selections as the particular second resource locator.

8. The method of claim 7, wherein tracking respective selections of each resource locator includes excluding a selection of each resource locator using a corresponding keyboard shortcut key.

9. The method of claim 1, wherein the data includes instructions to:
display an object in a first color in the user interface before assigning the keyboard shortcut key to the second resource locator; and
display the object in a second color, different from the first color, after assigning the keyboard shortcut key to the second resource locator.

10. The method of claim 1, wherein a keyboard shortcut key is a key on a keyboard connected to a display device in which the user interface is displayed.

11. A computer storage medium encoded with a computer program, the program comprising instructions that when executed by data processing apparatus cause the data processing apparatus to perform operations comprising:
determining that a first web page referenced by a first resource locator is displayed in a user interface, wherein the first web page referenced by the first resource locator includes second resource locators, each of the second resource locators respectively referencing a corresponding second web page;
determining that a likelihood of selection of a particular second resource locator in the first web page is greater than respective likelihoods of selection of each of the remaining second resource locators in the first web page; and
generating data defining a keyboard shortcut key to the particular second resource locator such that a selection of the keyboard shortcut key results in a selection of the particular second resource locator, wherein the data includes instructions that:
cause a display of an indicator in the user interface indicating that the keyboard shortcut key is assigned to the particular second resource locator, and
cause a request for the corresponding second web page in response to the selection of the keyboard shortcut key.

12. The medium of claim 11, wherein:
the first web page is referenced by a third web page that, in turn, is referenced by a third resource locator; and
determining that the likelihood of selection of the particular second resource locator is greater than the respective likelihoods of selection of each of the remaining second resource locators comprises:
determining, for each second resource locator, a similarity measure that is a measure of similarity of the first resource locator, the second resource locator, and the third resource locator; and
determining that a similarity measure for the particular second resource locator is greater than a similarity measure of each other second resource locator, and, in response, determining that the likelihood of selection of a particular second resource locator in the first web page is greater than respective likelihoods of selection of each of the remaining second resource locators in the web page.

13. The medium of claim 12, wherein determining a similarity measure that is a measure of similarity of the first resource locator, the second resource locator, and the third resource locator comprises, for each second resource locator:
generating a candidate resource locator, the candidate resource locator based on the third resource locator and the first resource locator;
comparing the candidate resource locator to each of the second resource locators to identify a second resource locator that is most similar to the candidate resource locator; and
identifying the most similar second resource locator as the particular second resource locator.

14. The medium of claim 13, wherein identifying the most similar second resource locator as the particular second resource locator comprises verifying that the candidate resource locator references an existing web page and only identifying the most similar second resource locator as the particular second resource locator in response to a positive verification.

15. The medium of claim 13, wherein:
the third resource locator and the first resource locator include common address data and variable address data, and wherein the common address data are the same for each of the third and first resource locators, and the variable address data for the first resource locator is different from the variable address data for the third resource locator; and
wherein generating the candidate resource locator comprises:
identifying the common address data from the first resource locator and the third resource locator;
determining a pattern change defined by the variable address data of the first resource locator and the variable address data of the third resource locator; and
generating candidate variable address data based on the pattern change and the common address data of the first resource locator and the variable address data of the third resource locator; and
identifying the most similar second resource locator as the particular second resource locator comprises identifying the second resource locator that most closely matches a combination of the common address data and the candidate variable address data.

16. The medium of claim 11, the operations further comprising determining that the likelihood of selection of the particular second resource locator to display the corresponding web page in the user interface is greater than the respective likelihood of selection of each of the remaining second resource locators of a plurality of resource locators comprises determining that a number of times that selections of the particular second resource locator were received from the first web page in the past is greater than each respective number of times that selections of each of the remaining resource locators were received from the first web page in the past.

17. The medium of claim 16, the operations further comprising:
tracking occurrences of displaying the first web page;
tracking respective selections of each second resource locator from the display of the first web page;
determining the second resource locator with most tracked selections; and
identifying the second resource locator with most tracked selections as the particular second resource locator.

18. The medium of claim 17, wherein tracking respective selections of each resource locator includes excluding a selection of each resource locator using a corresponding keyboard shortcut key.

19. The medium of claim 11, wherein the data includes instructions to:
display an object in a first color in the user interface before assigning the keyboard shortcut key to the second resource locator; and
display the object in a second color, different from the first color, after assigning the keyboard shortcut key to the second resource locator.

20. The medium of claim 11, wherein a keyboard shortcut key is a key on a keyboard connected to a display device in which the user interface is displayed.

21. A system comprising:
data processing apparatus; and
a computer storage medium encoded with a computer program, the program comprising instructions that when executed by the data processing apparatus cause the data processing apparatus to perform operations comprising:
determining that a first web page referenced by a first resource locator is displayed in a user interface, wherein the first web page referenced by the first resource locator includes second resource locators, each of the second resource locators respectively referencing a corresponding second web page;
determining that a likelihood of selection of a particular second resource locator in the first web page is greater than respective likelihoods of selection of each of the remaining second resource locators in the first web page; and
generating data defining a keyboard shortcut key to the particular second resource locator such that a selection of the keyboard shortcut key results in a selection of the particular second resource locator, wherein the data includes instructions that:
cause a display of an indicator in the user interface indicating that the keyboard shortcut key is assigned to the particular second resource locator, and
cause a request for the corresponding second web page in response to the selection of the keyboard shortcut key.

22. The system of claim 21, wherein:
the first web page is referenced by a third web page that, in turn, is referenced by a third resource locator; and
determining that the likelihood of selection of the particular second resource locator is greater than the respective likelihoods of selection of each of the remaining second resource locators comprises:
determining, for each second resource locator, a similarity measure that is a measure of similarity of the first resource locator, the second resource locator, and the third resource locator; and
determining that a similarity measure for the particular second resource locator is greater than a similarity measure of each other second resource locator, and, in response, determining that the likelihood of selection of a particular second resource locator in the first web page is greater than respective likelihoods of selection of each of the remaining second resource locators in the web page.

23. The system of claim 22, wherein determining a similarity measure that is a measure of similarity of the first resource locator, the second resource locator, and the third resource locator comprises, for each second resource locator:
generating a candidate resource locator, the candidate resource locator based on the third resource locator and the first resource locator;
comparing the candidate resource locator to each of the second resource locators to identify a second resource locator that is most similar to the candidate resource locator; and
identifying the most similar second resource locator as the particular second resource locator.

24. The system of claim 23, wherein identifying the most similar second resource locator as the particular second resource locator comprises verifying that the candidate resource locator references an existing web page and only identifying the most similar second resource locator as the particular second resource locator in response to a positive verification.

25. The system of claim 23, wherein:
the third resource locator and the first resource locator include common address data and variable address data, and wherein the common address data are the same for each of the third and first resource locators, and the variable address data for the first resource locator is different from the variable address data for the third resource locator; and
wherein generating the candidate resource locator comprises:
identifying the common address data from the first resource locator and the third resource locator;
determining a pattern change defined by the variable address data of the first resource locator and the variable address data of the third resource locator; and
generating candidate variable address data based on the pattern change and the common address data of the first resource locator and the variable address data of the third resource locator; and
identifying the most similar second resource locator as the particular second resource locator comprises identifying the second resource locator that most closely matches a combination of the common address data and the candidate variable address data.

26. The system of claim 21, the operations further comprising determining that the likelihood of selection of the particular second resource locator to display the corresponding web page in the user interface is greater than the respective likelihood of selection of each of the remaining second resource locators of a plurality of resource locators comprises determining that a number of times that selections of the particular second resource locator were received from the first web page in the past is greater than each respective number of times that selections of each of the remaining resource locators were received from the first web page in the past.

27. The system of claim 26, the operations further comprising:
tracking occurrences of displaying the first web page;
tracking respective selections of each second resource locator from the display of the first web page;
determining the second resource locator with most tracked selections; and
identifying the second resource locator with most tracked selections as the particular second resource locator.

28. The system of claim 27, wherein tracking respective selections of each resource locator includes excluding a selection of each resource locator using a corresponding keyboard shortcut key.

29. The system of claim 21, wherein the data includes instructions to:
display an object in a first color in the user interface before assigning the keyboard shortcut key to the second resource locator; and
display the object in a second color, different from the first color, after assigning the keyboard shortcut key to the second resource locator.

30. The system of claim 21, wherein a keyboard shortcut key is a key on a keyboard connected to a display device in which the user interface is displayed.
